(19) United States
(12) Patent Application Publication
(10) Pub. No.: US 2013/0249950 A1
(43) Pub. Date: Sep. 26, 2013

(54) HAND GESTURES WITH THE NON-DOMINANT HAND

(71) Applicants: Alaa Abou Mahmoud, Dracut, MA (US); Fang Lu, Billerica, MA (US); Paul R. Bastide, Boxford, MA (US); Ralph E. LeBlanc, Pepperell, MA (US)

(72) Inventors: Alaa Abou Mahmoud, Dracut, MA (US); Fang Lu, Billerica, MA (US); Paul R. Bastide, Boxford, MA (US); Ralph E. LeBlanc, Pepperell, MA (US)

(73) Assignee: International Business Machines Corporation, Armonk, NY (US)

(21) Appl. No.: 13/425,513

(22) Filed: Mar. 21, 2012

(51) Int. Cl. G06F 3/041; G09G 5/00

(52) U.S. Cl. 345/660; 345/173; 345/672

(57) ABSTRACT

A hand placement detection unit is configured to detect information indicating use of a user's non-dominant hand to interact with the touchscreen of a mobile device. An interface management unit is configured to modify user interface elements for use of the user's non-dominant hand. The interface management unit is configured to determine a layout for the modified user interface elements and other graphics appearing in the touchscreen. The display unit is configured to presents the layout. The layout includes the modified user interface elements and the other graphics.

### BACKGROUND

Embodiments of the inventive subject matter generally relate to the field of mobile devices, and, more particularly, to adapting user interface of a mobile device for use of the non-dominant hand.

When interacting with mobile touchscreen interfaces, users may have different experiences when using their dominant hands versus non-dominant hands. Right-handed individuals may have difficulty effectively interacting with a user interface when using their left hand. Certain touch buttons may be located in specific areas of a touchscreen based on ergonomics. For example, for right hand use, touch buttons are located in the left side for easy interaction via the right hand thumb. Similarly, for left hand use, touch buttons may be located on the right side for easy interaction via the left hand thumb.

### SUMMARY

Embodiments of the inventive subject matter include a method to present user interface elements on a touchscreen of a mobile device. The method detects information indicating use of a user's non-dominant hand to interact with the touchscreen. The method modifies the user interface elements for use with the user's non-dominant hand. The method determines a layout for the modified user interface elements and other graphics appearing in the touchscreen. The method presents the layout on a display unit of the mobile device. The layout includes the modified user interface elements and the other graphics.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of adapting layout of user interface for the use of the non-dominant hand.

FIG. 2 depicts an example conceptual diagram of selected components of a mobile device to adapt the layout of user interface for the mobile device.

FIG. 3 illustrates a flow diagram of example operations to adjust user interface elements for a mobile device on detecting use of the non-dominant hand.

FIG. 4 depicts an example mobile device.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to an interface management unit performing operations to adapt user interface elements, embodiments do not necessarily require the interface management unit. In other instances, well-known instruction instances, protocols, structures and techniques have not been shown in detail in order not to obfuscate the description.

An interface management unit in a mobile device adapts user interfaces when users use their non-dominant hand or simultaneously use their non-dominant hand with their dominant hand to interact with the mobile device. The interface management unit receives information from a hand placement detection unit to determine whether the user is using their dominant hand, their non-dominant hand or simultaneously using both hands. The interface management unit further receives information from the hand placement detection unit when the user switches from their dominant hand to their non-dominant hand and vice-versa. The hand placement detection unit detects hand placement using one or more of a camera, a pressure feedback sensor, a screen sensor, and fingerprint information. The interface management unit receives information about placement of a hand(s) in proximity to the touchscreen of the mobile device. The interface management unit adjusts user interface elements using information about placement of the hand(s). For example, the interface management unit magnifies certain user interface elements when a user utilizes the non-dominant hand to interact with the mobile device. The interface management unit also adds buffer elements (e.g., additional space around icons) to increase tolerance levels for certain user interface elements. The interface management unit can use fingerprint information to determine magnifying ratios for user interface elements. The interface management unit can also utilize fingerprint information to determine size of buffer elements. The interface management unit can rearrange certain user interface elements along with magnifying certain user interface elements. For example, when there is not enough space to add buffer elements, the interface management unit moves the user interface elements elsewhere. The interface management unit magnifies or rearranges user interface elements proactively (i.e., before the non-dominant hand actually interacts with user interface) to enhance usability of a touchscreen interface.

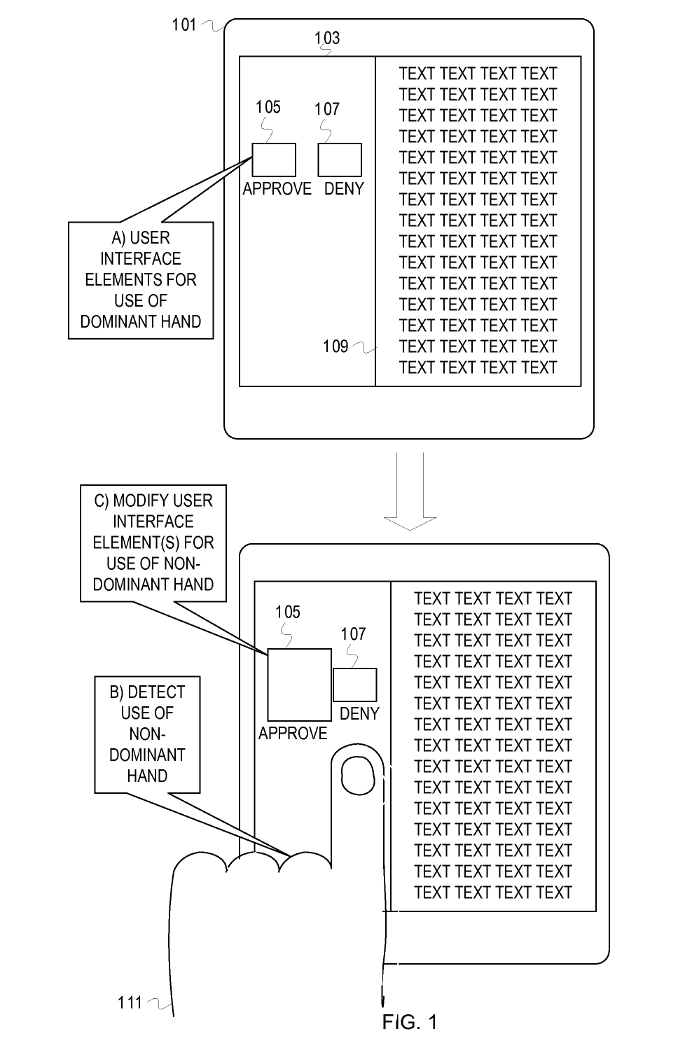

FIG. 1 depicts an example conceptual diagram of adapting the layout of user interface for use of a user's non-dominant hand. FIG. 1 depicts multiple entities including a mobile device 101, a touchscreen 103, a text area 109, a non-dominant hand 111, a user interface element 105 and a user interface element 107. The non-dominant hand 111 depicts the non-dominant hand of a user. For example, a user primarily utilizes his right hand to interact with the touchscreen of a mobile device. In this example, the user's dominant hand is his right hand and his non-dominant hand is his left hand. The mobile device 101 can be a mobile phone, a tablet, a portable digital assistant (PDA), etc. The touchscreen 103 can be a resistive touchscreen, a capacitive touchscreen, etc. The user interface elements 105 and 107 (e.g., any suitable graphical elements) are user interface elements of an application or system code running on the mobile device 101. The text area 109 is a text area of the application or system running on the mobile device 101. The non-dominant hand 111 interacts with the mobile device 101 by tapping on the user interface elements 105 and 107. FIG. 1 depicts adapting a layout of the mobile device's user interface in stages A-C.

At stage A, the touchscreen 103 of the mobile device 101 displays user interface elements 105 and 107 for use by a user's dominant hand. The user interface elements 105 and 107 are equally sized.

At stage B, the mobile device 101 detects use of a user's non-dominant hand 111. For example, the mobile device 101 detects use of the non-dominant 111 hand using a camera. The mobile device 101 can also detect use of the non-dominant hand 111 using one or more of pressure sensors, screen sensors and fingerprint information. The mobile device 101 includes a hand placement detection unit (not shown in FIG. 1) to receive hand placement data from an input device(s) and/or a sensor(s). The hand placement detection unit processes data to determine whether the dominant hand or the non-dominant hand is in use to interact with user interface.

At stage C, the mobile device 101 modifies a user interface element(s) for use by the user's non-dominant hand 111. The mobile device 101 modifies the user interface element(s) by magnifying the user interface element 105. The mobile device 101 includes an interface management unit to modify the user interface element 105. The interface management unit can modify the user interface element 105 using overlay magnification or inline magnification. In overlay magnification, the interface management unit spreads the magnified user interface element over neighboring user interface elements. In inline magnification, the interface management unit magnifies a user interface element within a certain space. The interface management unit does not overlay the magnified user interface element over neighboring user interface elements in inline magnification. The interface management unit can add buffer elements or modify the size of buffer elements while magnifying a user interface element. A buffer element refers to an area of tolerance corresponding to a user interface element on the touchscreen 103. For example, a user interface element with a size of 100 pixels has a buffer element of size 10 pixels. When a user taps on the user interface element within a boundary of 110 pixels, the mobile device 101 recognizes the tap as a selection of the user element. A buffer element can also be an area between two neighboring user interface elements; the area, when tapped, is not recognized as a selection of either of the two user interface elements. In some embodiments, when space is not available to add buffer elements or to magnify a user interface element, the interface management unit rearranges user interface elements.

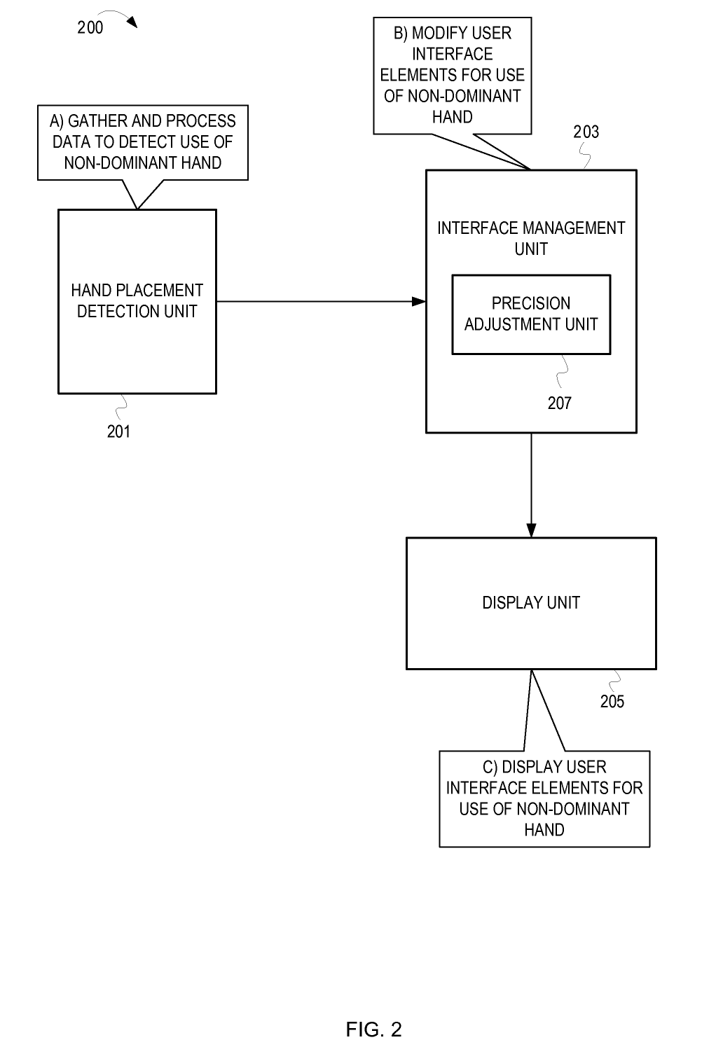

FIG. 2 depicts an example conceptual diagram of selected components of a mobile device capable of adapting user interface layouts for a mobile device. FIG. 2 depicts a mobile device 200 including a hand placement detection unit 201, an interface management unit 203 and a display unit 205. The hand placement detection unit 201 can include hardware and/or software components to determine placement of a user's hand with respect to the mobile device 200. The hand placement detection unit 201 also detects whether the user is using a dominant hand or non-dominant hand to interact with the mobile device 200. The hand placement detection unit 201 determines the use of the dominant or the non-dominant hand using previous data records related to the user's interaction with the mobile device 200 (e.g., a user profile). The hand placement detection unit 201 can determine use of the user's dominant or non-dominant hand based on user preferences (e.g., manual configuration of user settings). The interface management unit 203 includes program instructions to modify user interface elements based on information received from the hand placement detection unit 201. A precision adjustment unit 207 in the interface management unit 203 includes hardware and/or program instructions to adjust precision of user interface elements and reduce errors.

The display unit 205 includes hardware and/or software components to display user interface for use by a user's non-dominant hand. The display unit 205 displays user interface elements based on information received from the interface management unit 203. FIG. 2 depicts a sequence of stages A through C to adapt the layout of user interface for use by a user's non-dominant hand.

At stage A, the hand placement detection unit 201 gathers and processes data to detect use of the non-dominant hand. The hand placement detection unit 201 can receive data about the placement of hand from one or more of a camera, a pressure feedback sensor, a screen sensor, etc. For example, the hand placement detection unit 201 receives snapshots of a user's hand from a camera and determines a trajectory of the hand from a wireframe image based on the snapshots. The hand placement detection unit 201 then determines whether the hand is the user's dominant hand or the non-dominant hand, based on the trajectory of the hand. The hand placement detection unit 201 can also detect simultaneous use of both hands, and which hand is primarily used for interaction with the mobile device 200. The hand placement detection unit 201 can receive and process pressure feedback data to determine the position of a hand's palm and fingers relative to the mobile device 200. For example, the hand placement detection unit 201 may receive data about ambient air pressure to determine the position of palm and fingers relative to the mobile device 200. The hand placement detection unit 201 can receive data from the screen sensor to determine how a hand interacts with the mobile device 200. The hand placement detection unit 201 can further determine the placement of hand using fingerprint information. For example, the hand placement detection unit 201 compares the angle of fingerprint interacting with the mobile device 200 with originally stored fingerprints. Based on the fingerprint data, the hand placement detection unit 201 determines whether a user is using a dominant hand or non-dominant hand to interact with the mobile device 200. The stored fingerprint data includes fingerprint data for the dominant hand and/or the non-dominant hand for multiple users. The fingerprint data can be stored on the basis of user profiles, user settings, etc. The hand placement detection unit 201 can also determine the use of both hands (the dominant hand and the non-dominant hand) at the same time using the fingerprint information. The hand placement detection unit 201 sends information about hand placement to the interface management unit 203.

At stage B, the interface management unit 203 modifies user interface elements for use of the non-dominant hand. For example, the interface management unit 203 receives information from the hand placement detection unit 201 indicating the use of the non-dominant hand. The interface management unit 203 receives information from the hand placement detection unit 201 in real time to proactively modify the user interface elements. For example, the interface management unit 203 receives the trajectory of the non-dominant hand from the hand placement detection unit 201. The interface management unit 203 magnifies a user interface element when the non-dominant hand is in proximity of the user interface element. In some embodiments, the interface management unit 203 reactively modifies the user interface elements. For example, the user initially uses his dominant hand for interaction and then switches to his non-dominant hand for interaction. The interface management unit 203 modifies the user interface elements based on user's reactions. The precision adjustment unit 207 in the interface management unit 203 adds buffer elements to user interface elements when one or more user interface elements are magnified. The precision adjustment unit 207 also utilizes the pressure feedback information, the fingerprint information and information from the screen sensor to adjust precision of user interface elements. For example, the precision adjustment unit 207 increases/decreases touch sensitivity of certain user interface elements using the pressure feedback information and information from the screen sensor. The precision adjustment unit 207 utilizes the fingerprint information to determine the size of user interface elements and the size of buffer elements. In some embodiments, the precision adjustment unit 207 only increases the size of a touch-point area for a user interface element, without increasing the size of the user interface element. The interface management unit 203 can rearrange user interface elements when the touchscreen does not have enough available area to magnify the user interface elements. The interface management unit 203 can move certain user interface elements to a different position for display on the touchscreen of the mobile device 200. The interface management unit 203 can also interchange the position of certain user interface elements for use of the non-dominant hand. For example, an application has a text area and two user interface elements for ‘yes’ and ‘no’ respectively. The user interface element for ‘yes’ is displayed on the left side of text area and the user interface element for ‘no’ is displayed on the right side of text area for use of the dominant hand. On receiving the information about use of the non-dominant hand, the interface management unit 203 interchanges the position of the user interface elements for ‘yes’ and ‘no’. In some embodiments, when the user interface elements are very close, the interface management unit 203 allows the user to flip through action using gestures. For example, the interface management unit 203 magnifies one user interface element at a time when the non-dominant hand moves close to the tightly spaced user interface elements. The interface management unit 203 can also magnify and/or rearrange certain user interface elements when both hands are in use simultaneously. For example, the interface management unit 203 can magnify and/or rearrange user interface elements in accordance with the hand primarily used for interaction. The interface management unit 203 also magnifies and/or rearranges user interface elements when the user switches the hand primarily used for interaction. The interface management unit 203 can also modify a time-based user interface when enough space for display on the touchscreen is not available. For example, when enough space is not available to magnify user interface element or add buffer elements, the interface management unit 203 displays a dynamic confirm action screen. The dynamic confirm action screen allows the user to cancel an action within a specified time interval. The interface management unit 203 can also increase the time interval for such dynamic confirm action screens (or popup windows) associated with certain user interface elements. The interface management unit 203 rearranges other sections (e.g., text area, taskbar, etc.) of user interface when certain user interface elements are modified. The interface management unit 203 determines a layout for user interfaces and sends the layout to the display unit 205. The components of the interface management unit 203 can record statistics of user's interaction with user interface to improve the accuracy of modification of user interface elements.

At stage C, the display unit 205 displays user interface for use by the non-dominant hand. The display unit 205 includes any suitable display device technologies (e.g., touchscreen), drivers and/or firmware for the display devices. The display unit 205 receives the layout for the user interface from the interface management unit 203, and the display unit 205 displays user interface. Although not depicted in the figure, the display unit 205 may be connected to the hand placement detection unit 201.

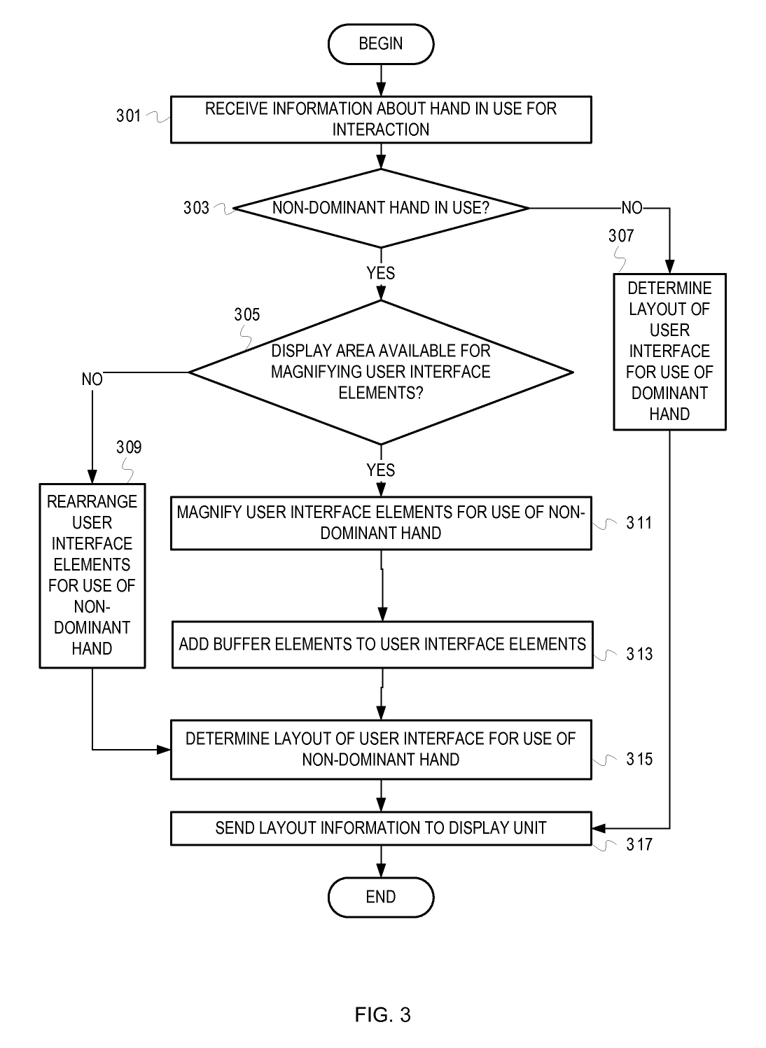

FIG. 3 illustrates a flow diagram of example operations to adjust user interface elements for a mobile device upon detecting use of the non-dominant hand.

At block 301, an interface management unit in a mobile device receives information about the hand in use for interaction with the mobile device. The interface management unit receives the information from a hand placement detection unit in the mobile device.

At block 303, the interface management unit determines whether the hand in use for interaction with the mobile device is the user's dominant hand or the non-dominant hand. If the hand in use for interaction with the mobile device is the dominant hand, control flows to block 305. If the hand in use for interaction with the mobile device is the non-dominant hand, control flows to block 307.

At block 305, the interface management unit determines whether display area is available for magnifying user interface elements. The interface management unit determines whether enough space is available for display on the mobile device's touchscreen to display magnified user interface elements. In some embodiments, the interface management unit also determines if enough area is available to add buffer elements to the user interface elements. If enough area is available for display on the touchscreen of the mobile device, control flows to block 311. If enough area is not available on the touchscreen of the mobile device, control flows to block 309.

At block 309, the interface management unit rearranges user interface elements for use by the non-dominant hand. The interface management unit changes the position of certain user interface elements for display on the touchscreen of the mobile device. For example, the interface management unit rearranges interface elements so they are better accessible by the user's non-dominant thumb. From block 309, control flows to block 315.

At block 311, the interface management unit magnifies user interface elements for use of the non-dominant hand. The interface management unit magnifies certain user interface elements for display on the touchscreen of the mobile device. In some embodiments, the interface management unit only increases the size of touch-point areas for certain user interface elements and does not magnify the user interface elements.

At block 313, the interface management unit adds buffer elements to one or more magnified user interface elements. For example, a precision adjustment unit in the interface management unit determines size of buffer elements and adds buffer elements to the magnified user interface elements. In some embodiments, the interface management unit adds buffer elements to certain user interface elements that are not magnified.

At block 315, the interface management unit determines a layout of user interface for use of the non-dominant hand. The interface management unit adjusts the position of the user interface elements to determine a layout of user interface for display on the touchscreen. For example, the interface management unit determines positions of the magnified user interface elements and the neighboring user interface elements. The interface management unit also determines positions of the rearranged user interface elements and other sections (e.g., text area, taskbar, etc.) for display on the touchscreen.

At block 307, the interface management unit determines a layout of user interface for use of the dominant hand. The interface management unit does not modify any user interface elements in user interface when the dominant hand is in use. From block 307, control flows to block 317.

At block 317, the interface management unit sends the layout information to a display unit. The interface management unit sends the information about layout of user interface as determined at block 307 or block 315.

Those of ordinary skill in the art should understand that the depicted flow diagram is an example to aid in understanding the inventive subject matter. The flow diagram should not be used to limit the scope of the claims. Embodiments can perform additional operations not depicted, fewer than the depicted operations, the operations in a different order, the operations in parallel, etc. For example, embodiments are not limited to either magnifying user interface elements or rearranging user interface elements for use of the non-dominant hand. Embodiments can have an interface management unit to magnify user interface elements and rearrange the user interface elements to determine a layout of user interface. The flow diagram only depicts operations performed at certain time instance. For example, the control from block 317 can loop back to block 301 as long as the interface management unit continues to receive information from the hand placement detection unit.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

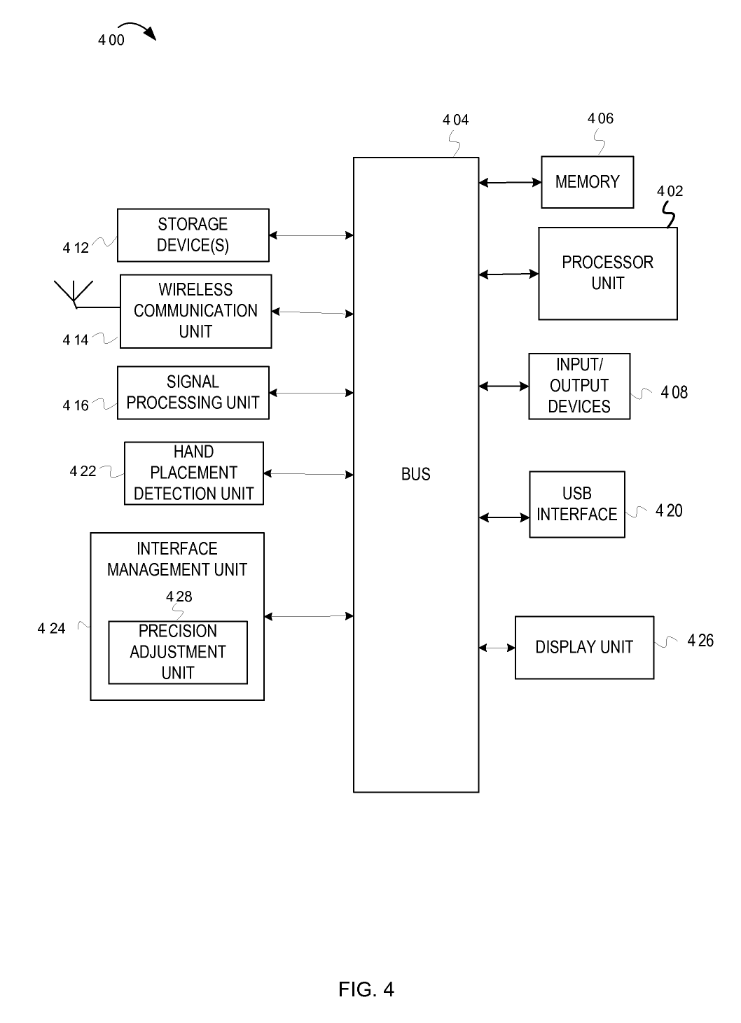

FIG. 4 depicts an example mobile device 400. The mobile device 400 includes a processor unit 402 (possibly including multiple processors, multiple cores, multiple nodes, and/or implementing multi-threading, etc.), a memory 406, input/output devices 408, a signal processing unit 416, a USB interface 420, a hand placement detection unit 422, an interface management unit 424, a precision adjustment unit 428 and a display unit 426. The precision adjustment unit 428 is embodied in the interface management unit 424. The hand placement detection unit 422 receives hand placement data, processes the hand placement data and sends the processed data to the interface management unit 424. The interface management unit 424 performs operations to modify one or more user interface elements and determines a layout of user interface for display on a touchscreen of the mobile device 400. The precision adjustment unit 428 in the interface management unit 424 adjusts precision (e.g., adds buffer elements to user interface elements) for user interface elements. The interface management unit 424 sends the layout information to the display unit 426. The display unit 426 displays user interface on the input/output devices 408. The hand placement detection unit 422, the interface management unit 424 and the display unit 426 may be a hardware chip (e.g., PLA, PAL, FPGA, etc.) programmed with program instructions to perform the functionality as described above. The hand placement detection unit 422, the interface management unit 424 and the display unit 426 may be implemented with an application specific integrated circuit, in logic implemented in the processor unit 402, in a co-processor on a peripheral device or card, etc. In addition, at least some of the functionality of the hand placement detection unit 422, the interface management unit 424 and the display unit 426 may be embodied as program instructions in the memory 406 or the storage device(s) 412. The memory 406 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The input/output devices 408 may include a touchscreen, a screen sensor(s), a pressure sensor(s), a camera, etc. The signal processing unit 416 may include audio DSP's, video DSP's, etc. The USB interface 420 may consist of a Mini-USB, a Micro-USB, etc. The mobile device 400 also includes a bus 404 (e.g., PCI, ISA, PCI-Express, HyperTransport®, InfiniBand®, NuBus, etc.), a wireless communication unit 414 (e.g., a GSM interface, a CDMA interface, a Bluetooth interface, an Infrared interface, a FM interface, a GPS interface, a WLAN interface etc.) and a storage device(s) 412 (e.g., SD card, SIM card, etc.). Further, realizations may include fewer or additional components not illustrated in FIG. 4 (e.g., video cards, audio cards, additional network interfaces, peripheral devices, etc.). The processor unit 402, the input/output devices 408, the storage device(s) 412, the wireless communication unit 414, the signal processing unit 416, the hand placement detection unit 422, the interface management unit 424, the display unit 426 and the USB interface 420 are coupled to the bus 404. Although illustrated as being coupled to the bus 404, the memory 406 may be coupled to the processor unit 402.

While the embodiments are described with reference to various implementations and exploitations, it will be understood that these embodiments are illustrative and that the scope of the inventive subject matter is not limited to them. In general, techniques for modifying user interface elements for use of the non-dominant hand as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
presenting user interface elements on a touchscreen of a mobile device;
detecting information indicating use of a user's non-dominant hand to interact with the touchscreen;
modifying the user interface elements for use with the user's non-dominant hand;
determining a layout for the modified user interface elements and other graphics appearing in the touchscreen; and
presenting the layout on a display unit of the mobile device, wherein the layout includes the modified user interface elements and the other graphics.

2. The method of claim 1, wherein detecting the information indicating use of the user's non-dominant hand comprises receiving information from a hand placement detection unit, wherein the hand placement detection unit gathers and processes data from a camera.

3. The method of claim 1, wherein modifying the user interface elements for use with the user's non-dominant hand comprises:
magnifying certain of the user interface elements;
adding buffer elements to certain of the user interface elements, wherein a buffer element is an area of tolerance corresponding to a user interface element; and
rearranging certain of the user interface elements for display on the touchscreen.

4. The method of claim 3 further comprising:
determining the size of user interface elements and the size of buffer elements based on one or more of pressure feedback information, fingerprint information, and information from a screen sensor.

5. The method of claim 1, wherein determining a layout for the modified user interface elements and other graphics appearing in the touchscreen comprises adjusting the position of the modified user interface elements for display on the touchscreen.

6. The method of claim 1 further comprising:
modifying the user interface elements for use with the user's non-dominant hand before the user interacts with the mobile device.

7. The method of claim 1 further comprising:
receiving information indicating simultaneous use of the user's dominant hand and a non-dominant hand of the user and modifying the user interface elements based on the simultaneous use.

8. The method of claim 7 further comprising:
receiving information indicating switching of the user's dominant hand to a non-dominant hand for interaction with the mobile device and modifying user interface elements based on the switching.

9. A computer program product for modifying user interface elements for use of a user's non-dominant hand, the computer program product comprising:
a computer readable storage medium having computer usable program code embodied therewith, the computer usable program code comprising a computer usable program code configured to:
present the user interface elements on a touchscreen of a mobile device;
detect information indicating use of the user's non-dominant hand to interact with the touchscreen;
modify the user interface elements for use with the user's non-dominant hand;
determine a layout for the modified user interface elements and other graphics appearing in the touchscreen; and
present the layout on a display unit of the mobile device, wherein the layout includes the modified user interface elements and the other graphics.

10. The computer readable storage medium of claim 9, wherein the computer usable program code configured to detect the information indicating use of the user's non-dominant hand comprises computer usable program code configured to receive information from a hand placement detection unit, wherein the hand placement detection unit gathers and processes data from a camera.

11. The computer readable storage medium of claim 9, wherein the computer usable program code configured to modify the user interface elements for use with the user's non-dominant hand comprises computer usable program code configured to:
magnify certain of the user interface elements;
add buffer elements to certain of the user interface elements, wherein a buffer element is an area of tolerance corresponding to a user interface element; and
rearrange certain of the user interface elements for display on the touchscreen.

12. The computer readable storage medium of claim 11, wherein the computer usable program code is further configured to determine the size of user interface elements and the size of buffer elements based on one or more of pressure feedback information, fingerprint information, and information from a screen sensor.

13. The computer readable storage medium of claim 9, wherein the computer usable program code configured to determine a layout for the modified user interface elements and other graphics appearing in the touchscreen comprises computer usable program code configured to adjust the position of the modified user interface elements for display on the touchscreen.

14. The computer readable storage medium of claim 9, wherein the computer usable program code is further configured to modify the user interface elements for use with the user's non-dominant hand before the user interacts with the mobile device.

15. An apparatus comprising:
a processor;
a touchscreen;
a network interface coupled with the processor;
a computer readable storage medium having computer usable program code embodied therewith, the computer usable program code comprising a computer usable program code configured to:
present user interface elements on a touchscreen of a mobile device;
detect information indicating use of the user's non-dominant hand to interact with the touchscreen;
modify the user interface elements for use with the user's non-dominant hand;
determine a layout for the modified user interface elements and other graphics appearing in the touchscreen; and
present the layout on a display unit of the mobile device, wherein the layout includes the modified user interface elements and the other graphics.

16. The apparatus of claim 15, wherein the computer usable program code configured to detect the information indicating use of the user's non-dominant hand comprises receiving information from a hand placement detection unit, wherein the hand placement detection unit gathers and processes data from a camera.

17. The apparatus of claim 15, wherein the computer usable program code configured to modify the user interface elements for use with the user's non-dominant hand comprises the computer usable program code configured to:
magnify certain of the user interface elements;
add buffer elements to certain of the user interface elements, wherein a buffer element is an area of tolerance corresponding to a user interface element; and
rearrange certain of the user interface elements for display on the touchscreen.

18. The apparatus of claim 17, wherein the computer usable program code is further configured to determine the size of user interface elements and the size of buffer elements based on one or more of pressure feedback information, fingerprint information, and information from a screen sensor.

19. The apparatus of claim 15, wherein the computer usable program code configured to determine a layout for the modified user interface elements and other graphics appearing in the touchscreen comprises computer usable program code configured to adjust the position of the modified user interface elements for display on the touchscreen.

20. The apparatus of claim 15, wherein the computer usable program code is further configured to modify the user interface elements for use with the user's non-dominant hand before the user interacts with the mobile device.
